(19) United States
(12) Patent Application Publication
(10) Pub. No.: US 2026/0141226 A1
(43) Pub. Date: May 21, 2026

(54) COMPUTATIONAL DEVICE AND METHOD FOR DEEP NEURAL NETWORKS

(71) Applicant: Sogang University Research & Business Development Foundation, Seoul (KR)

(72) Inventors: Sungju RYU, Seoul (KR); Hyunmin KIM, Seoul (KR)

(73) Assignee: Sogang University Research & Business Development Foundation, Seoul (KR)

(21) Appl. No.: 19/379,908

(22) Filed: Nov. 5, 2025

(30) Foreign Application Priority Data
Nov. 15, 2024 (KR) 10-2024-0162901

(51) Int. Cl. G06N 3/048; G06N 3/063

(52) U.S. Cl. CPC G06N 3/048; G06N 3/063

(57) ABSTRACT

Provided is a computational device that processes a computation for a DNN including a plurality of computational blocks. Each of the computational blocks includes a plurality of CIM computational units, each of which stores weight data and performs a matrix multiplication operation on input data and the weight data, and a hub core computational unit placed at a center of the plurality of CIM computational units, and that delivers the input data or the weight data to a respective CIM computational unit, and accumulates a partial sum output by the respective CIM computational unit, delivers the partial sum to an adjacent CIM computational unit, or performs a function operation on the partial sum.

### CROSS-REFERENCE TO RELATED APPLICATIONS

This application claims priority under 35 U.S.C. § 119 to Korean Patent Application No. 10-2024-0162901 filed on November 15, 2024, in the Korean Intellectual Property Office, the disclosures of which are incorporated by reference herein in their entireties.

### BACKGROUND

Embodiments of the present disclosure described herein relate to a computational device for a deep neural network (DNN).

Nowadays, a DNN or a DNN technology has evolved rapidly and is being used in a variety of fields such as image processing, natural language processing, healthcare, and speech recognition. To improve the performance of a DNN model, a hardware accelerator for parallel processing, such as GPU and NPU, have emerged. The hardware accelerator may process the large amount of computation required by the DNN, enabling faster training and inference of an AI model. However, the hardware accelerator needs to read out input data and weight data from a memory before each computation. Given the large number of computations performed in DNN tasks, the burden of frequent access to a memory during computation may occur, and a computing-in-memory (CIM) technique have been proposed to address this issue. The CIM reduces communication between a processor and a memory by directly performing computations within a memory array, thereby providing a fast computation method with high energy efficiency.

In more detail, many analog CIM approaches using current summation, charge sharing, and capacitive coupling have been adopted in various memory types, including ReRAM, SRAM, DRAM, and flash memory, and are known to maximize computing efficiency by turning on several wordlines. However, analog circuits suffer from poor output accuracy due to process, voltage, and temperature (PVT) variations.

On the other hand, digital CIMs are designed as SRAM arrays that perform multiplication by using logic gates (XORs) near the memory cells, and do not perform analog summation, and thus a fully digital addition tree completes the summation.

While the variety of CIM memory types and calculation methods provide many design options for many applications, the CIM approach is limited in terms of array capacity. As a result, several CIM array architectures have been recently investigated.

In the meantime, CIM arrays may communicate with other arrays by using a network-on-chip (NoC) architecture. However, the CIM arrays with widely used mesh-NoCs suffer from significant performance degradation due to communication bottlenecks between CIM units. In particular, in a NoC structure, processing elements (PEs) consistently communicate with each other, and a data bus between two different PEs may only be occupied by a single piece of data. In a conventional mesh-NoC, when a CIM unit first sends data to another CIM unit, another CIM unit may not use the data bus and may need to wait until the bus is unoccupied.

To solve these issues of the prior art, the present disclosure proposes a CIM-based computational device with a novel structure.

(Patent Document 1) there is a prior art disclosed as U.S. Patent Publication No. 2021-0150328 (Title of invention: Hierarchical Hybrid Network on Chip Architecture for Compute-in-memory Probabilistic Machine Learning Accelerator).

### SUMMARY

Embodiments of the present disclosure provide a CIM-based computational device with a novel structure capable of eliminating communication bottlenecks between computational units, and an operating method thereof.

The technical problem to be solved by embodiments of the present disclosure is not limited to the above-described technical problems, and other technical problems may be deduced.

According to an embodiment, a computational device that processes a computation for a DNN includes a plurality of computational blocks. Each of the computational blocks includes a plurality of Computing-in-Memory (CIM) computational units, each of which stores weight data and performs a matrix multiplication operation on input data and the weight data, and a hub core computational unit placed at a center of the plurality of CIM computational units, and that delivers the input data or the weight data to a respective CIM computational unit, and accumulates a partial sum output by the respective CIM computational unit, delivers the partial sum to an adjacent CIM computational unit, or performs a function operation on the partial sum.

According to an embodiment, a computation method performed by a computational device for a DNN includes the computational device includes a plurality of computational blocks, each of which includes a plurality of CIM computational units and a hub core computational unit located at a center of the plurality of CIM computational units. (a) receiving, by the hub core computational unit, input data or weight data for a matrix multiplication operation to be performed in each layer of the DNN, (b) delivering, by the hub core computational unit, the input data or the weight data to a respective CIM computational unit within the computational block, (c) accumulating, by the hub core computational unit, a partial sum output by the respective CIM computational unit, delivering the partial sum to an adjacent CIM computational unit, or performing a function operation on the partial sum so as to be output, and (d) outputting, by the hub core computational unit, the result of the matrix multiplication operation.

### BRIEF DESCRIPTION OF THE FIGURES

The above and other objects and features of the present disclosure will become apparent by describing in detail embodiments thereof with reference to the accompanying drawings.

FIG. 1 is a diagram for describing a computational process for a DNN in a computational device, according to an embodiment of the present disclosure.

FIG. 2 illustrates a configuration of a computational device using a conventional mesh NoC structure.

FIG. 3 illustrates an overall configuration of a computational device, according to an embodiment of the present disclosure.

FIG. 4 illustrates a detailed configuration of a computational block included in a computational device, according to an embodiment of the present disclosure.

FIG. 5 illustrates a detailed configuration of a hub core computational unit, according to an embodiment of the present disclosure.

FIG. 6 illustrates a data flow in a computational block, according to an embodiment of the present disclosure.

FIG. 7 is a flowchart illustrating a computation method, according to an embodiment of the present disclosure.

### DETAILED DESCRIPTION

Hereinafter, embodiments of the present disclosure will be described in detail with reference to the accompanying drawings such that those skilled in the art may easily implement the present disclosure. However, the present disclosure may be embodied in many different forms and should not be construed as limited to the embodiments set forth herein. In drawings, components or elements not associated with the detailed description may be omitted to describe the present disclosure clearly, and like reference numerals refer to like elements throughout this application.

Throughout this specification, when it is supposed that a portion is “connected” to another portion, this includes not only “directly connected” but also “electrically connected” to another element in between. Furthermore, when a portion “comprises” a component, it will be understood that it may further include another component, without excluding other components unless specifically stated otherwise.

The term “unit” in this specification includes a unit implemented by hardware, a unit implemented by software, and a unit implemented by both. Also, a single unit may be implemented by using two or more pieces of hardware, or two or more units may be implemented by a single piece of hardware. In the meantime, the term “unit” is not meant to be limited to software or hardware, and the “unit” may be configured to exist in an addressable storage medium or may be configured to play one or more processors. Therefore, as an example, “units” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” and components may be combined into a smaller number of “units” and components or may be divided into additional “units” and components. In addition, components and ‘units’ may be implemented to regenerate one or more CPUs within a device.

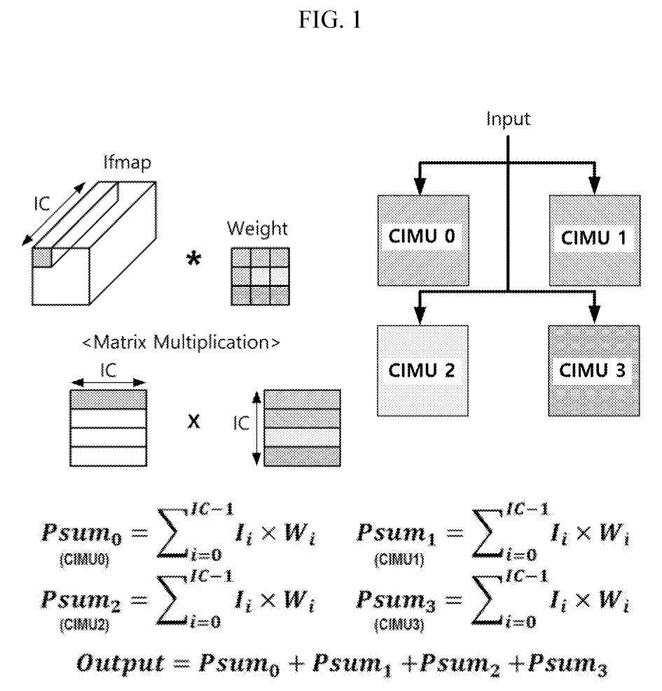

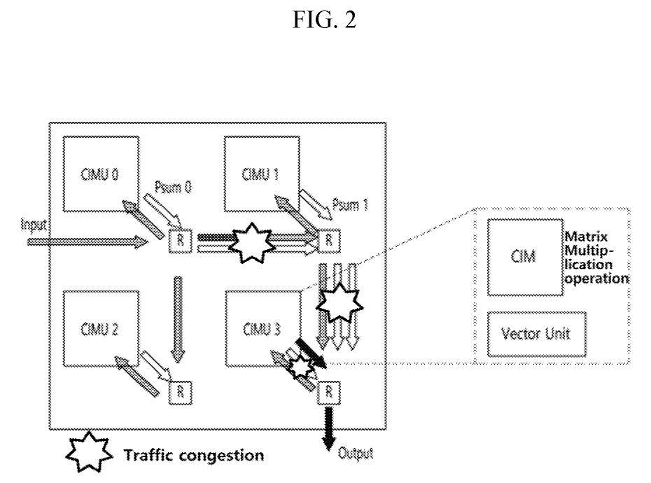

FIG. 1 is a diagram for describing a computational process for a DNN in a computational device, according to an embodiment of the present disclosure. FIG. 2 illustrates a configuration of a computational device using a conventional mesh NoC structure.

FIG. 1 illustrates the operation process of CNN DNN, and shows a process in which each of input data (input) and weight data (weight) is multiplied by a matrix. In this case, the input data may be data transmitted from an immediately previous layer, and the weight data may be pre-stored in a memory of CIM. For example, assuming that one computational block includes four CIM computational units CIM0 to CIM3, the input data may be split through tiling and may be delivered to each CIM computational unit. Moreover, each CIM computational unit independently performs a matrix multiplication operation on the split input data and the weight data stored in each CIM computational unit. The matrix multiplication operation results output by each CIM computational unit become partial sums Psums. When accumulation is performed to add all of these, the final matrix multiplication operation is output. In this way, the special function operation such as a batch normalization function operation or an activation function operation may be performed on the result of accumulating partial sum.

In the meantime, FIG. 2 illustrates a computational device using a conventional mesh NoC structure, in which a router in charge of data communication is connected to each of the computational units CIMU0 to CIMU3.

First of all, the input data coming into the router connected to the first CIM computational unit CIMU0 is delivered to another router for the remaining CIM computational units by using a tiling method of weight distribution. Then, an input arriving at a router connected to the second CIM computational unit CIMU1 is delivered to a router connected to the fourth CIM computational unit CIMU3, and thus all the CIM computational units receive the input in a broadcast manner. Furthermore, after all the CIM computational units complete a tiling matrix multiplication computation, partial sums Psum0 to Psum2 respectively corresponding to the CIM computational units are transmitted to the fourth CIM computational unit CIMU3. The fourth CIM computational unit CIMU3 performs an operation of calculating the partial sum Psum3 through the matrix multiplication operation, and also performs an operation of accumulating each of the partial sums Psum0 to Psum3.

However, because a data bus is shared in a process of delivering the input delivered in a broadcast manner and the partial sums Psum0 to Psum2, which are calculated by each CIM computational unit, to the fourth CIM computational unit CIMU3, a communication bottleneck occurs between routers connected to the CIM computational units in a mesh NoC topology, as shown in FIG. 2.

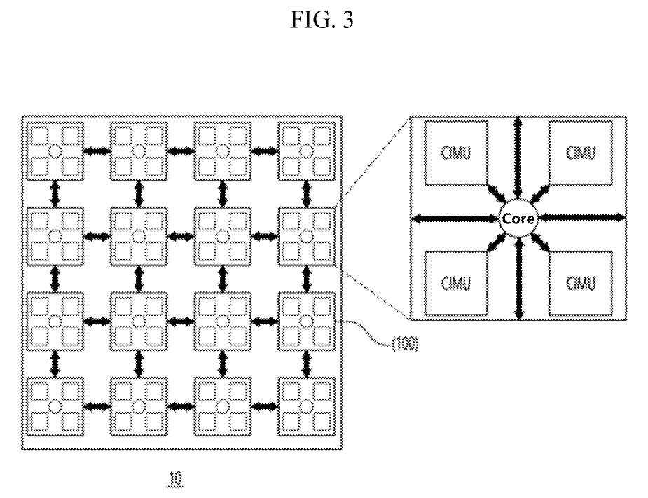

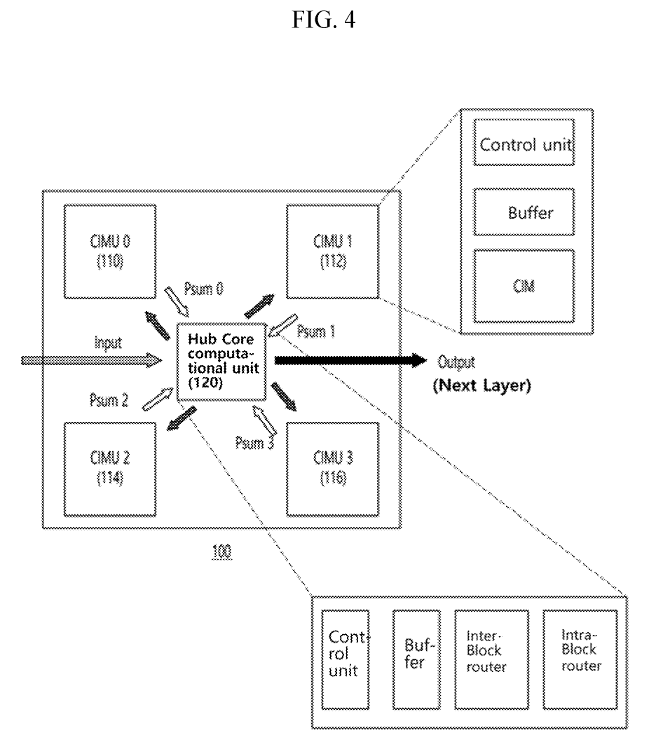

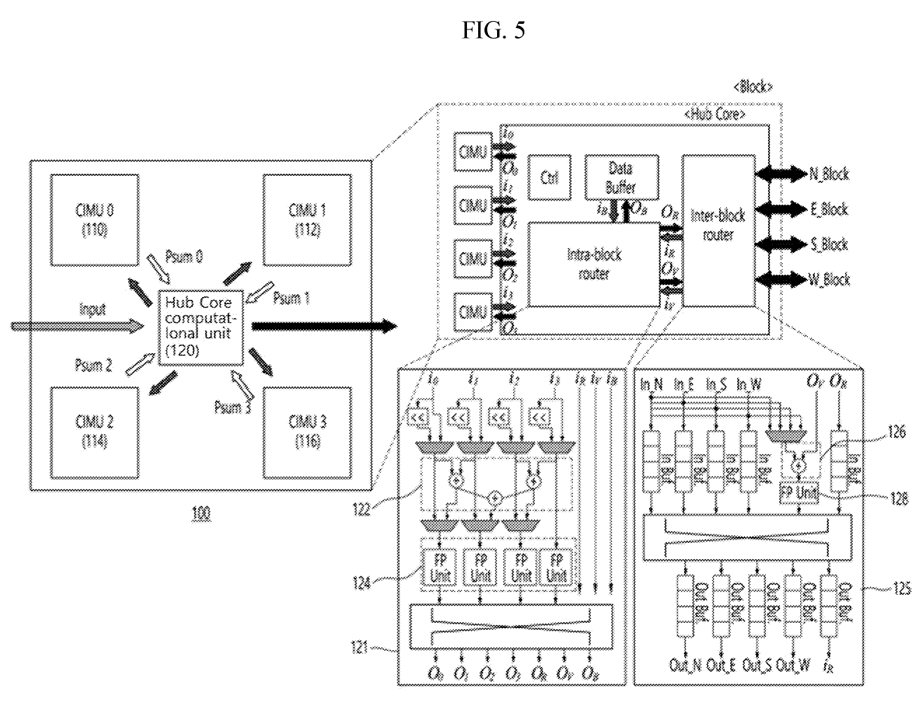

FIG. 3 illustrates an overall configuration of a computational device, according to an embodiment of the present disclosure. FIG. 4 illustrates a detailed configuration of a computational block included in a computational device, according to an embodiment of the present disclosure. FIG. 5 illustrates a detailed configuration of a hub core computational unit, according to an embodiment of the present disclosure.

Referring to FIG. 3, a computational device 10 may be formed by arranging a plurality of computational blocks 100 in the form of an array and may perform computational processing for a DNN on each computational block. The respective computational block 100 may include the same components therein, and may include a plurality of CIM computational units, and a hub core computational unit, which are features of the present disclosure.

The respective computational block 100 may correspond to a plurality of layers that constitute DNN, and may perform a computational processing operation in which the computational result of one computational block is delivered to another adjacent computational block, just as the computational result between layers in a DNN is passed.

Referring to FIG. 4, the respective computational block 100 includes a plurality of CIM computational units 110 to 116 and a core computational unit 120.

Each of the CIM computational units 110 to 116 stores a weight, which is the target of a matrix multiplication operation, and performs the matrix multiplication operation on input data and weight data. Each of the CIM computational units 110 to 116 receives the input data from the core computational unit 120 and transmits the partial sum Pisum, which is the result of the matrix multiplication operation, to the core computational unit 120. Meanwhile, each of the CIM computational units 110 to 116 includes a control device, a line buffer, and a CIM. This corresponds to the configuration of a typical CIM computational unit, and thus a detailed description of each configuration is omitted.

The hub core computational unit 120 is centrally connected to the plurality of CIM computational units 110 to 116. According to this structure, the hub core computational unit 120 has the same communication environment as the plurality of CIM computational units 110 to 116. Moreover, the hub core computational unit 120 receives the input data delivered from the outside, splits the input data for a matrix multiplication operation, delivers the split input data to each of the CIM computational units 110 to 116, receives the partial sums Psum0 to Psum3 respectively output by the CIM computational units 110 to 116, and accumulates each of the partial sums Psum0 to Psum3 to output the result of the matrix multiplication operation. Furthermore, the hub core computational unit 120 may process a special function operation of performing a batch normalization function operation or an activation function operation on the result of accumulating the partial sums. In this case, to accumulate the partial sums in the conventional technology, a vector unit included in a specific CIM computational unit is deleted from the corresponding CIM computational unit and is placed in the hub core computational unit 120.

In this way, the hub core computational unit 120 is placed at the center of each of the CIM computational units 110 to 116 to not only improve communication environments but also process a special function operation or the accumulation of partial sums performed by a specific CIM computational unit, thereby minimizing traffic congestion that occurred on a data bus as in the conventional technology. Besides, this configuration may reduce the amount of communication exchanged between a conventional CIM computational unit and a router.

The hub core computational unit 120 may include a control unit, a buffer, an inter-block router, and an intra-block router.

The buffer may be used as a shortcut buffer to temporarily store data from a shortcut path included in a DNN. Moreover, the buffer may be used to perform skip connection processing included in the DNN.

The intra-block router performs data communication between the CIM computational units 110 to 116 included in the computational block 100 including the

hub core computational unit 120. On the other hand, the inter-block router performs data communication between computational blocks located outside of the computational block 100 including the hub core computational unit 120, and primarily performs data communication with computational blocks located in the north, east, south, or west directions adjacent to the computational block 100.

Referring to FIG. 5, an intra-block router 121 may include a plurality of digital computational circuits, and may implement a partial sum accumulation unit 122 and a special function computational unit 124 through the plurality of digital computational circuits. The intra-block router may include a shift register (<<) that receives outputs i0 to i3 of the CIM computational units and shifts the outputs i0 to i3 by a predetermined number of bits, a primary multiplexer circuit that receives the output of the shift register and the outputs i0 to i3 of the CIM operation units and selectively outputs them, an adder (+) that sums the outputs of the multiplexer circuits, a secondary multiplexer circuit that receives the output of each adder and the output of the primary multiplexer circuit and selectively outputs the received result, and a floating-point computational unit (FP unit) that computes the output of the secondary multiplexer circuit and the output of the primary multiplexer circuit.

In this way, the partial sum accumulation unit 122 may include a plurality of adders, each of which adds the outputs of primary multiplexer circuits, and may perform an accumulation operation of adding the outputs of the CIM computational units through the plurality of adders. Moreover, the special function computational unit 124 may include a plurality of FP units. The special function computational unit 124 may receive the output of the primary multiplexer circuit or the output of the partial sum accumulation unit 122 from the secondary multiplexer circuit, and may perform an operation of the batch normalization function or an operation of the activation function by performing a floating-point operation on the received result.

Furthermore, an inter-block router 125 performs data communication with computational blocks located in the north, east, south, or west direction adjacent to the computational block 100. To this end, the inter-block router 125 may include input buffers that store data received from each computational block, a partial sum accumulation unit 126 that sums the data received from each computational block, a special function computational unit 128 that performs a floating-point operation based on the output of the partial sum accumulation unit 126, and an output buffer that stores data to be transmitted to surrounding computational blocks.

Next, a computation method performed by each computational block will be described in more detail. Each computational block may perform an intra-layer pipeline method and an inter-layer pipeline method. When weight data or input data of a layer is larger than the capacity of each CIM computational unit, the layer is split into a plurality of tensor tiles and mapped to a plurality of CIM computational units, which is called an intra-layer pipeline.

Otherwise, when the weight data or the input data of the layer is less than or equal to the capacity of each CIM computational unit, each CIM computational unit is responsible for a single layer, and each CIM computational unit is assigned an operation for each layer, which is called the inter-layer pipeline method. The computational block of the present disclosure may execute both methods.

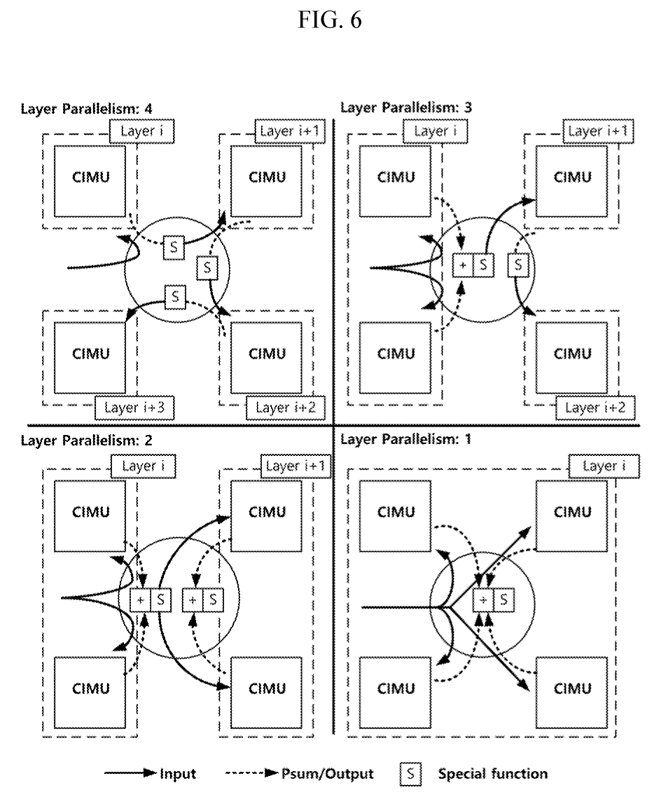

FIG. 6 illustrates a data flow in a computational block, according to an embodiment of the present disclosure.

The upper left side of FIG. 6 shows that different layers are assigned to a plurality of computational blocks, and shows that four computational blocks process four layers in parallel (layer parallelism: 4). In this case, the hub core computational unit 120 receives input data or weight data from the outside and then transmits the received data to each CIM computational unit. In this case, the hub core computational unit 120 performs an inter-layer pipeline operation, and sequentially delivers the partial sum output by each CIM computational unit to the adjacent CIM computational unit according to the connection order of each layer.

The computational result of a computational block responsible for the computation of a first layer (Layer i) may be delivered to a computational block responsible for the computation of a second layer (Layer i+1) through the hub core computational unit 120. Moreover, the computational result of the computational block responsible for the computation of the second layer (Layer i+1) may be delivered to a computational block responsible for the computation of a third layer (Layer i+2) through the hub core computational unit 120. This process may be sequentially performed between respective computational blocks. In the meantime, in a process of delivering each partial sum to an adjacent CIM computational unit, a special function operation of performing a batch normalization function or an activation function operation may be performed.

The upper right side of FIG. 6 shows a case where one layer is assigned to two computational blocks and a case where different layers are assigned to a plurality of computational blocks, and shows that four computational blocks process three layers in parallel (layer parallelism: 3). In other words, it shows a structure in which an inter-layer pipeline operation and an intra-layer pipeline operations are mixed. The hub core computational unit 120 splits the input data into two tensor tiles such that two computational blocks are responsible for the computation of the first layer (Layer i), delivers them to each computational block, and receives a partial sum of each computational block to perform an accumulation operation (intra-layer pipeline operation). Moreover, the accumulated partial sum may be delivered to the computational block responsible for the second layer (Layer i+1), and the computational results from the computational block responsible for the second layer (Layer i+1) may then be sequentially delivered to the computational block responsible for the third layer (Layer i+2) through the hub core computational unit 120 (inter-layer pipeline operation).

The lower left side of FIG. 6 shows that two computational blocks process two layers in parallel (layer parallelism: 2). The hub core computational unit 120 splits the input data into two tensor tiles such that two computational blocks are responsible for the computation of the first layer (Layer i), delivers them to each computational block, and receives and accumulates a partial sum of each computational block. In addition, the accumulated partial sum is split into two tensor tiles again and delivered to each computational block responsible for the computation of the second layer (Layer i+1), and the partial sum of each computational block is received and accumulated.

The lower right side of FIG. 6 shows that four computational blocks splits and processes one layer (layer parallelism: 1). This process shows that only the intra-layer pipeline operation is performed. The hub core computational unit 120 splits the input data into four tensor tiles such that four computational blocks are responsible for the computation of the first layer (Layer i), delivers them to each computational block, and receives and accumulates a partial sum of each computational block.

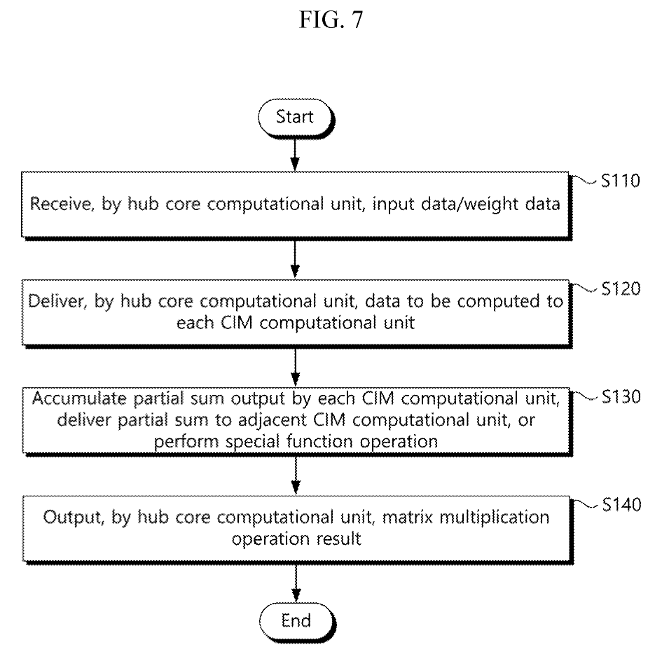

FIG. 7 is a flowchart illustrating a computation method, according to an embodiment of the present disclosure.

First of all, the hub core computational unit 120 receives input data or weight data for a matrix multiplication operation to be performed in each layer of a DNN (S110). The weight data may be stored in advance in each of the CIM computational units 110 to 116 before the input data is received. Moreover, the input data may be delivered by an inter-block router included in a hub core computational unit of an adjacent computational block.

Next, the hub core computational unit 120 delivers the input data or the weight data to each CIM computational unit within the computational block (S120). In this case, the size of data may be compared with the capacity of each CIM operation unit, and whether to split the input data or the weight data may be determined based on the comparison result.

As previously explained, an intra-layer pipeline operation of splitting the input data or the weight data when the size of the input data or the weight data for a specific layer constituting the DNN exceeds the capacity of each CIM computational unit, delivering the split input data or the split weight data to a plurality of CIM computational units, and allowing each CIM computational unit to perform a matrix multiplication operation based on the split input data or the split weight data may be performed.

Furthermore, an inter-layer pipeline operation of delivering the input data or the weight data for each layer to each CIM computational unit when the size of the input data or the weight data for a specific layer constituting the DNN is smaller than or equal to the capacity of each CIM computational unit, and allowing each CIM computational unit to perform a matrix multiplication operation for each layer may be performed.

Additionally, the intra-layer pipeline operation and the inter-layer pipeline operation may be performed in a mixed form within one computational block.

Next, the hub core computational unit 120 accumulates the partial sum output by each CIM computational unit, delivers the partial sum to an adjacent CIM computational unit, or performs a special function operation on the partial sum so as to be output (S130).

When the intra-layer pipeline operation described above is performed, the hub core computational unit 120 accumulates the partial sum output by each CIM computational unit. Moreover, when the inter-layer pipeline operation is performed, the partial sum output by each CIM computational unit may be sequentially delivered to the adjacent CIM computational unit depending on the connection order of layers. In this case, during a process of delivering each partial sum to adjacent CIM computational units, a special function operation such as a batch normalization function operation or an activation function operation may be processed.

Next, the hub core computational unit 120 outputs the matrix multiplication operation result (S140). The output value may be delivered to an adjacent computational block through an inter-block router, which may be utilized for computation in subsequent layers.

The method according to an embodiment of the present disclosure may also be embodied in the form of a recording medium including instructions executable by a computer, such as a program module executed by a computer. The computer-readable medium may be any available medium capable of being accessed by a computer, and may include all of a volatile medium, a nonvolatile medium, a removable medium, and a non-removable medium. In addition, the computer-readable medium may also include a computer storage medium. The computer-readable medium may include all of a volatile medium, a nonvolatile medium, a removable medium, and a non-removable medium, which are implemented by using a method or technology for storing information such as a computer-readable instruction, a data structure, a program module, or other data.

The method and the system according to an embodiment of the present disclosure have been described with regard to specific embodiments, but some or all of their components or operations may be implemented by using a computer system having general-purpose hardware architecture.

The above-mentioned description of the present disclosure is intended to be illustrative, and it should be understood by those skilled in the art that the present disclosure may be embodied in other specific forms without departing from the spirit or essential characteristics thereof. Therefore, the above-described embodiments are examples in all aspects, and should be construed not to be restrictive. For example, each component described in a single type may be implemented in a distributed manner, and similarly, components described as being distributed may be implemented in a combined form.

The scope of the present disclosure is defined by claims to be described below rather than the detailed description, and it should be interpreted that the scopes or claims of the present disclosure and all modifications or changed forms derived from the equivalent concept are included in the scopes of the present disclosure.

According to the above-mentioned problem solving means, unlike a computational block based on a conventional mesh-NoC structure, a centrally placed hub core computational unit performs both a partial sum accumulation operation and a special function operation, thereby minimizing traffic congestion on a data bus connecting each CIM computational unit and a router.

While the present disclosure has been described with reference to embodiments thereof, it will be apparent to those of ordinary skill in the art that various changes and modifications may be made thereto without departing from the spirit and scope of the present disclosure as set forth in the following claims.

At least one of the components, elements, modules, blocks, or the like (collectively "components" in this paragraph) represented by a unit or an equivalent indication (collectively “unit”) in the above embodiments, including the drawings such as FIGS. 1, 3, 4, 5 and 6, for example, unit such as control unit, hub core computational unit, CIM computational unit or the like, may carry out the above-described function or functions. These units may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a unit may be implemented by dedicated hardware, or by a processor (e.g., one or more programmed microprocessors and associated circuitry), or by a combination of dedicated hardware to perform some functions of the unit and a processor to perform other functions of the unit. Each unit of the embodiments may be physically separated into two or more interacting and discrete units without departing from the scope of the disclosure. Likewise, the units of the embodiments may be physically combined into more complex units without departing from the scope of the disclosure.

What is claimed is:

1. A computational device that processes a computation for a deep neural network (DNN), the computational device comprising:
a plurality of computational blocks,
wherein each of the computational blocks includes:
a plurality of Computing-in-Memory (CIM) computational units, each of which stores weight data and performs a matrix multiplication operation on input data and the weight data; and
a hub core computational unit placed at a center of the plurality of CIM computational units, and configured to deliver the input data or the weight data to a respective CIM computational unit, and to accumulate a partial sum output by the respective CIM computational unit, to deliver the partial sum to an adjacent CIM computational unit, or to perform a function operation on the partial sum.

2. The computational device of claim 1, wherein the hub core computational unit is configured to:
perform an intra-layer pipeline operation of splitting the input data or the weight data in response to a size of the input data or the weight data for a specific layer constituting the DNN greater than capacity of a respective CIM computational unit, delivering split input data based on the input data or split weight data based on the weight data to a plurality of CIM computational units, allowing the respective CIM computational unit to perform a matrix multiplication operation based on the split input data or the split weight data, and accumulating the partial sum output by the respective CIM computational unit.

3. The computational device of claim 1, wherein the hub core computational unit is configured to:
perform an inter-layer pipeline operation of delivering the input data or the weight data for each layer to a respective CIM computational unit in response to a size of the input data or the weight data for a specific layer constituting the DNN smaller than or equal to capacity of the respective CIM computational unit, and allowing the respective CIM computational unit to perform a matrix multiplication operation for each layer, and
wherein the hub core computational unit is configured to:
sequentially deliver the partial sum output by the respective CIM computational unit to an adjacent CIM computational unit depending on a connection order of layers.

4. The computational device of claim 1, wherein the hub core computational unit is configured to:
perform, in a mixed method, an intra-layer pipeline operation of splitting input data or weight data in response to a size of the input data or the weight data for a specific layer constituting the DNN greater than capacity of a respective CIM computational unit, delivering the split input data or the split weight data to a plurality of CIM computational units, allowing the respective CIM computational unit to perform a matrix multiplication operation based on the split input data or the split weight data, and accumulating the partial sum output by the respective CIM computational unit, and an inter-layer pipeline operation of delivering input data or weight data for each layer to a respective CIM computational unit in response to a size of the input data or the weight data for a specific layer constituting the DNN smaller than or equal to the capacity of the respective CIM computational unit, and allowing the respective CIM computational unit to perform a matrix multiplication operation for each layer; and
based on an order of layers of the DNN, deliver the result of the intra-layer pipeline operation to an adjacent CIM computational unit to be used for the inter-layer pipeline operation, or deliver the result of the inter-layer pipeline operation to an adjacent CIM computational unit, to be used for the intra-layer pipeline operation.

5. The computational device of claim 3, wherein the hub core computational unit is configured to:
in a process of delivering each partial sum to the adjacent CIM computational unit, process the function operation of performing a batch normalization function operation or an activation function operation.

6. The computational device of claim 4, wherein the hub core computational unit is configured to:
in a process of delivering each partial sum to the adjacent CIM computational unit, process the function operation of performing a batch normalization function operation or an activation function operation.

7. The computational device of claim 1, wherein the hub core computational unit includes:
an intra-block router configured to process data communication with the CIM computational units within the computational block; and
an inter-block router configured to process data communication with an external computational block adjacent to a computational block including the hub core computational unit,
wherein the intra-block router is further configured to:
deliver the input data to the respective CIM computational unit and accumulate the partial sum output by the respective CIM computational unit, and
wherein the inter-block router is further configured to:
deliver the result of the matrix multiplication operation to an adjacent external computational block.

8. The computational device of claim 7, wherein the intra-block router further is further configured to:
process the function operation of performing a batch normalization function operation or an activation function operation on the result of accumulating the partial sum.

9. A computation method performed by a computational device for a DNN, the computation method comprising:
the computational device includes a plurality of computational blocks, each of which includes a plurality of CIM computational units and a hub core computational unit located at a center of the plurality of CIM computational units,
(a) receiving, by the hub core computational unit, input data or weight data for a matrix multiplication operation to be performed in each layer of the DNN;
(b) delivering, by the hub core computational unit, the input data or the weight data to a respective CIM computational unit within the computational block;
(c) accumulating, by the hub core computational unit, a partial sum output by the respective CIM computational unit, delivering the partial sum to an adjacent CIM computational unit, or performing a function operation on the partial sum so as to be output; and
(d) outputting, by the hub core computational unit, the result of the matrix multiplication operation.

10. The method of claim 9, wherein the operation (b) includes:
performing an intra-layer pipeline operation of splitting the input data or the weight data in response to a size of the input data or the weight data for a specific layer constituting the DNN greater than capacity of a respective CIM computational unit, delivering split input data based on the input data or split weight data based on the weight data to the plurality of CIM computational units, and allowing the respective CIM computational unit to perform a matrix multiplication operation based on the split input data or the split weight data, and
wherein the operation (c) includes:
performing an operation of accumulating the partial sum output by the respective CIM computational unit.

11. The method of claim 9, wherein the operation (b) includes:
performing an inter-layer pipeline operation of delivering input data or weight data for each layer to a respective CIM computational unit in response to a size of the input data or the weight data for a specific layer constituting the DNN smaller than or equal to capacity of the respective CIM computational unit, and allowing the respective CIM computational unit to perform a matrix multiplication operation for each layer, and
wherein the operation (c) includes:
sequentially delivering the partial sum output by the respective CIM computational unit to an adjacent CIM computational unit depending on a connection order of layers.

12. The method of claim 9, wherein the operation (b) includes:
performing, in a mixed method, an intra-layer pipeline operation of splitting input data or weight data in response to a size of the input data or the weight data for a specific layer constituting the DNN greater than capacity of a respective CIM computational unit, delivering the split input data or the split weight data to the plurality of CIM computational units, and allowing the respective CIM computational unit to perform a matrix multiplication operation based on the split input data or the split weight data, and
performing an inter-layer pipeline operation of delivering input data or weight data for each layer to a respective CIM computational unit in response to a size of the input data or the weight data for a specific layer constituting the DNN smaller than or equal to the capacity of the respective CIM computational unit, and allowing the respective CIM computational unit to perform a matrix multiplication operation for each layer, and
wherein the operation (c) includes:
based on an order of layers of the DNN, after the result of the intra-layer pipeline operation is delivered to an adjacent CIM computational unit, allowing the result to be used for the inter-layer pipeline operation, or after the result of the inter-layer pipeline operation is delivered to an adjacent CIM computational unit, allowing the result to be used for the intra-layer pipeline operation.

13. The method of claim 11, wherein the operation (c) includes:
in a process of delivering each partial sum to an adjacent CIM computational unit, processing the function operation of performing a batch normalization function operation or an activation function operation.

14. The method of claim 12, wherein the operation (c) includes:
in a process of delivering each partial sum to an adjacent CIM computational unit, processing the function operation of performing a batch normalization function operation or an activation function operation.
